(19) United States
(12) Patent Application Publication
(10) Pub. No.: US 2019/0221460 A1
(43) Pub. Date: Jul. 18, 2019

(54) METHOD OF MANUFACTURING A SEMICONDUCTOR DEVICE

(71) Applicant: KOKUSAI ELECTRIC CORPORATION, Tokyo (JP)

(72) Inventors: Yasuhiro MIZUGUCHI, Toyama-shi (JP); Toshiyuki KIKUCHI, Toyama-shi (JP); Naofumi OHASHI, Toyama-shi (JP); Tadashi TAKASAKI, Toyama-shi (JP); Shun MATSUI, Toyama-shi (JP)

(73) Assignee: KOKUSAI ELECTRIC CORPORATION, Tokyo (JP)

(21) Appl. No.: 16/144,723

(22) Filed: Sep. 27, 2018

Related U.S. Application Data
(63) Continuation of application No. 15/920,377, filed on Mar. 13, 2018, now abandoned.

(30) Foreign Application Priority Data
Jan. 18, 2018 (JP) 2018-006405

(51) Int. Cl. H01L 21/67; G05B 19/418; G06F 21/44; G06F 21/31; C23C 16/52

(52) U.S. Cl. CPC H01L 21/67276; H01L 21/67167; H01L 21/67207; G05B 19/4189; G05B 2219/36542; G06F 21/31; C23C 16/52; G05B 2219/45031; G06F 21/44

(57) ABSTRACT

A technique is described that provides efficient production management of a substrate processing system that includes a substrate processing apparatus and a mobile terminal. The substrate processing apparatus includes: at least one reactor where a substrate is processed; a transfer chamber adjacent to at least one reactor; a detector that detects a state of at least one reactor, a state of the transfer chamber, and generates monitored apparatus information representing the state of at least one reactor, and the state of the transfer chamber. A mobile terminal is authenticated based on information transmitted from the mobile terminal; a first transceiver transmits apparatus information that contains an apparatus management number and monitored apparatus information to the mobile terminal, and wherein the mobile terminal includes: a second transceiver that receives the apparatus information transmitted from the first transceiver; and a display device that displays the apparatus information received by the second transceiver.

### CROSS-REFERENCE TO RELATED PATENT APPLICATION

This non-provisional U.S. patent application is a continuation of U.S. patent application Ser. No. 15/920,377 and claims priority under 35 U.S.C. § 119 of Japanese Patent Application No. 2018-006405, filed on Jan. 18, 2018, the entire contents of which are hereby incorporated by reference.

### BACKGROUND

### 1. Field

The present disclosure relates to a method of manufacturing a semiconductor device, a substrate processing system and a substrate processing apparatus.

### 2. Description of the Related Art

A substrate processing apparatus including a reactor is used in a manufacturing process of a semiconductor device, for example. In the substrate processing apparatus, information on the operation of the substrate processing apparatus is displayed by an input/output device such as a display. The input/output device is provided at a location which is easily accessible by an administrator of the substrate processing apparatus. For example, the input/output device is provided such that the input/output device is accessible from a main corridor of a clean room. Specifically, the input/output device is provided on a sidewall of an atmospheric transfer chamber adjacent to a loading port of the substrate processing apparatus. The substrate processing apparatus, which is provided in the clean room where semiconductor devices are manufactured, can be managed via network and also via mobile terminals operated by users. Multiple substrate processing apparatuses can be also managed via network.

In order to improve the yield of semiconductor devices, more efficient production management is necessary.

### SUMMARY

Described herein is a technique capable of providing more efficient production management.

According to one aspect of the technique described herein, there is provided a substrate processing system including: a substrate processing apparatus; and a mobile terminal, wherein the substrate processing apparatus includes: at least one reactor where a substrate is processed; a transfer chamber provided adjacent to the at least one reactor; a detector configured to detect a state of the at least one reactor, a state of the transfer chamber or both, and generate monitored apparatus information representing the state of the at least one reactor, the state of the transfer chamber or both; a mobile terminal authenticator configured to authenticate the mobile terminal based on information transmitted from the mobile terminal; and a first transceiver configured to transmit apparatus information containing an apparatus management number and the monitored apparatus information to the mobile terminal, and wherein the mobile terminal includes: a second transceiver configured to receive the apparatus information transmitted from the first transceiver; and a display device configured to display the apparatus information received by the second transceiver.

### BRIEF DESCRIPTION OF THE DRAWINGS

FIG. 1 schematically illustrates a clean room where substrate processing apparatuses are accommodated.

FIG. 2 schematically illustrates a substrate processing apparatus according to an embodiment described herein.

FIG. 3 schematically illustrates a vertical cross-section of the substrate processing apparatus taken along the line α-α′ in FIG. 2

FIG. 4 is a block diagram illustrating a controller of the substrate processing apparatus and peripherals thereof according to the embodiment.

FIG. 5 schematically exemplifies a data table of the substrate processing apparatus according to the embodiment.

FIG. 6 schematically exemplifies another data table of the substrate processing apparatus according to the embodiment.

FIG. 7 schematically exemplifies yet another data table of the substrate processing apparatus according to the embodiment.

FIG. 8 schematically illustrates a reactor of the substrate processing apparatus according to the embodiment.

FIG. 9 schematically exemplifies an apparatus information table according to the embodiment.

FIG. 10 schematically illustrates a mobile terminal according to the embodiment.

FIG. 11 is a block diagram illustrating a controller of the mobile terminal and peripherals thereof according to the embodiment.

FIG. 12 schematically exemplifies a management number table of the mobile terminal according to the embodiment.

FIG. 13 schematically exemplifies a main user table of the mobile terminal according to the embodiment.

FIG. 14 schematically exemplifies a sub-user table included in the mobile terminal according to the embodiment.

FIG. 15 exemplifies a flowchart illustrating a substrate processing according to the embodiment.

FIG. 16 exemplifies a flowchart of a method of managing a substrate processing system according to the embodiment.

### DETAILED DESCRIPTION

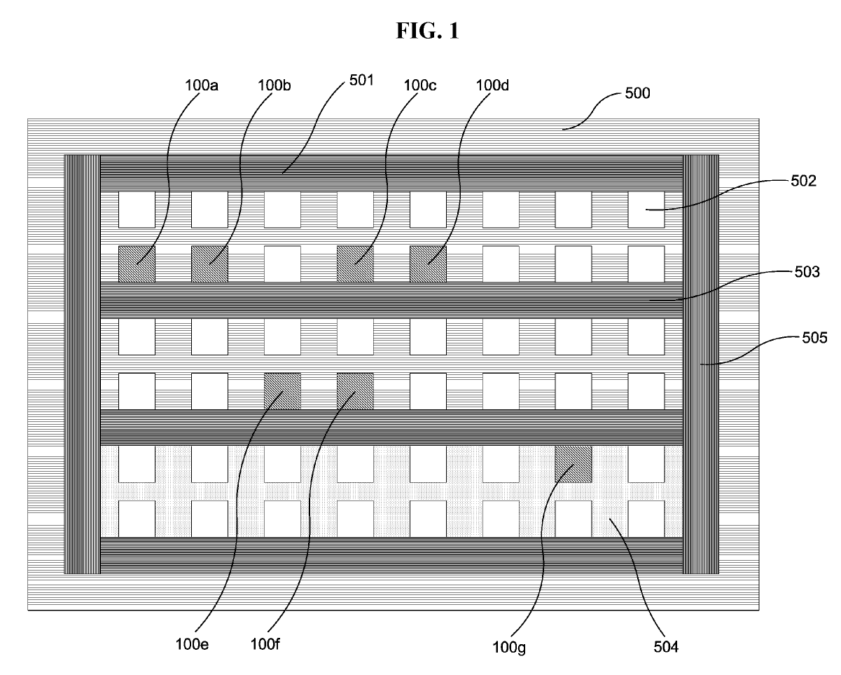

Hereinafter, an embodiment will be described with reference to the FIGS. 1 through 16.

First, major issues related to managing the production of semiconductor devices will be described. In the recent semiconductor device production, the following issues exist.

The first issue is that production efficiency be improved. In order to improve the production efficiency of semiconductor devices, the number of reactors in a substrate processing apparatus or the number of substrate processing apparatuses in operation in a clean room in the factory of the device manufacturer are increased.

Recently, various films and circuits have been developed, and it is necessary that a clean room correspond to producing the various films and circuits. For example, a substrate processing apparatus used in a specific process may be replaced with a high-performance substrate processing apparatus capable of producing a new circuit, or a substrate processing apparatus capable of forming a completely different film. Specifically, a conventional substrate processing apparatus for forming a silicon nitride film is replaced with a substrate processing apparatus capable of forming a thinner silicon nitride film, or a substrate processing apparatus capable of forming a silicon nitride film is replaced with a substrate processing apparatus capable of forming a silicon nitride film. Thus, as various films and circuits are developed, conventional substrate processing apparatuses may be replaced with new substrate processing apparatuses. During the maintenance of various substrate processing apparatuses provided in a clean room, a maintenance personnel performs maintenance while viewing apparatus information displayed on a display provided in each substrate processing apparatus. In this situation, a higher production efficiency may be achieved when an administrator working for the substrate processing apparatus manufacturer reduces the down time by shortening the maintenance time of the substrate processing apparatus.

The second issue is that the management costs be reduced. In order to reduce the management costs, device manufacturers are reducing the number of administrators. The substrate processing apparatus manufacturer can also reduce the number of parts used in the substrate processing apparatus and construct a structure that can be managed by a small number of personnel.

The third issue is that the security level of the clean room is elevated every year. A device manufacturer that manages a clean room must prevent leakage of information to competitors.

As a countermeasure to the leakage of information, at least one of the following can be performed. The first countermeasure is not to open information such as production management information to the substrate processing apparatus manufacturer. For example, the permission of accessing the production management information set such that an administrator working for the substrate processing apparatus manufacturer is not granted access to the production management information while an administrator working for a device manufacturer is granted access to the production management information. By setting the security clearance of each administrator differently, the leakage of information can be prevented.

The second countermeasure is close the wireless communication system covering the clean room to the substrate processing apparatus manufacturer. For example, in order to prevent an administrator working for the substrate processing apparatus manufacturer from establishing a communication with a third party who is outside the clean room, the administrator working for the substrate processing apparatus manufacturer is prohibited from carrying a communication terminal into the clean room. Alternately, the wireless LAN system in the clean room may be configured such that the administrator working for the substrate processing apparatus manufacturer is not able to use the wireless LAN system in the clean room. Accordingly, the administrator working for the substrate processing apparatus manufacturer can be prevented from managing the substrate processing apparatuses in the clean room by using the wireless communication system or the wireless LAN system.

Hereinafter, techniques for solving at least one of the above-described issues will be described.

(1) Configuration of Substrate Processing System

FIG. 1 schematically illustrates a clean room 500 where substrate processing apparatuses are arranged. Hereinafter, “clean room” may be abbreviated to as “CR.” FIG. 1 is a plan view of the clean room. A floor 501 of the clean room is illustrated in FIG. 1. In order to distinguish the region where substrate processing apparatuses 100a through 100g are arranged from the region where substrate processing apparatus 502 are arranged, the floor 501 is divided into a main corridor 503, a maintenance region 504 and a sub corridor 505.

Substrate processing apparatuses 100a through 100g, 502 are disposed such that the front sides of the substrate processing apparatuses face the main corridor 503. The substrate processing apparatuses 100a through 100g and 502 in the clean room are managed by each manufacturer of the substrate processing apparatuses 100a through 100g and 502 to protect confidentiality. Referring to FIG. 1, the substrate processing apparatuses 100a through 100g indicated by oblique pattern are manufactured by a first manufacturer, and the substrate processing apparatus 502 is manufactured by a second manufacturer different from the first manufacturer. Therefore, the first manufacturer manages the substrate processing apparatuses 100a through 100g (i.e. apparatuses to be managed). While seven substrate processing apparatuses 100a through 100g are to be managed by the first manufacturer in FIG. 1, the number of the substrate processing apparatuses managed by the first manufacturer is not limited to seven apparatuses. In addition, the substrate processing apparatuses 100a through 100g may have substantially the same configuration or may have different configurations.

Each of the substrate processing apparatuses 100a through 100g includes a controller 400 and is controlled by controller 400. Each controller 400 is capable of establishing an electrical connection with a mobile terminal 300 which will be described later, and the mobile terminal 300 is capable of acquiring information from the substrate processing apparatuses 100a through 100g. The substrate processing apparatus manufacturer, that is, the administrator working for the first manufacturer, uses the mobile terminal 300 to view the information of each of the substrate processing apparatuses 100a through 100g. Also, while one mobile terminal 300 is exemplified, multiple mobile terminals 300 may be used to acquire information from the substrate processing apparatuses and view the information of each of the substrate processing apparatuses.

Herein, the semiconductor processing apparatuses 100a through 100g and the mobile terminal 300 are collectively referred to as “semiconductor processing system.”

(2) Configuration of Substrate Processing Apparatus

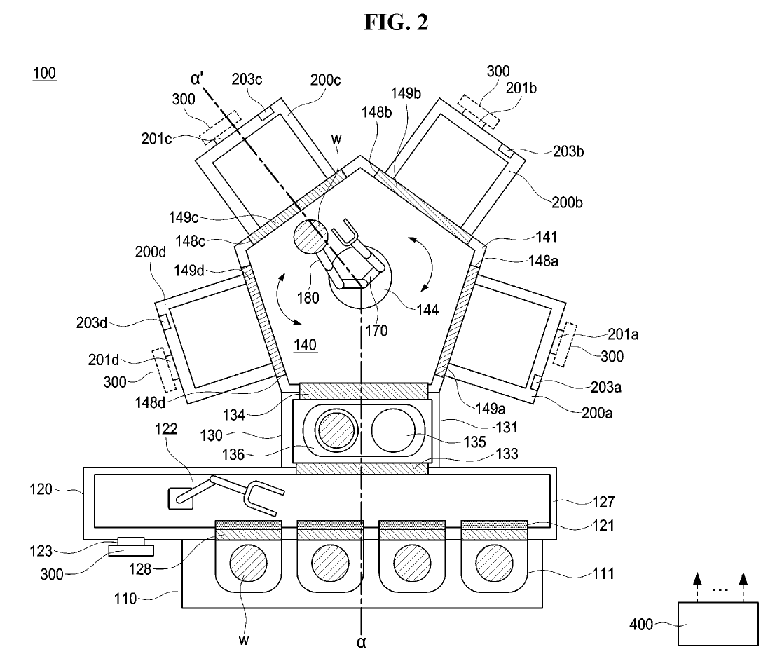

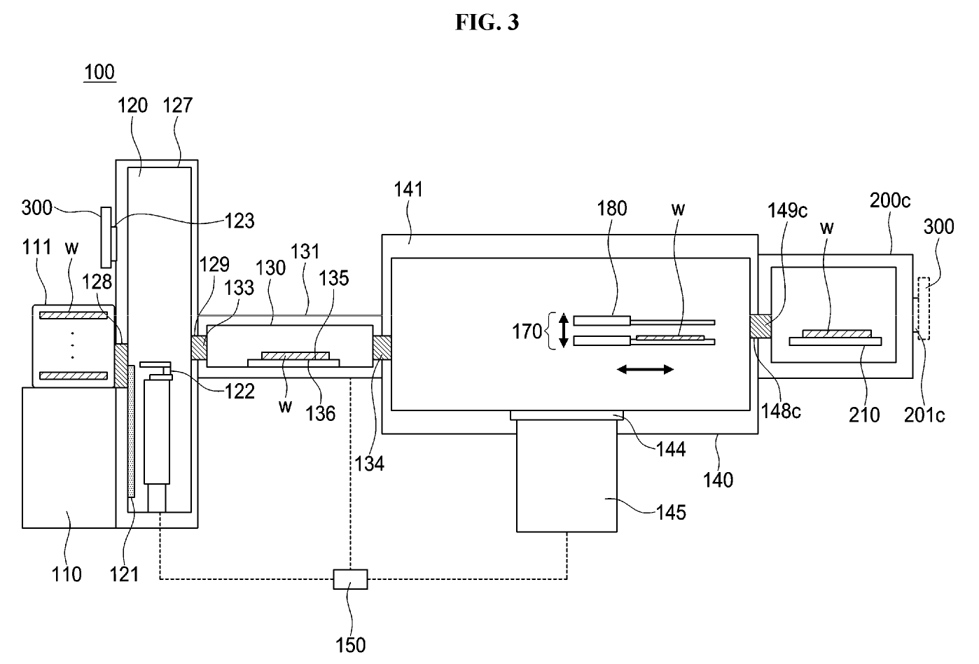

First, a substrate processing apparatus according to the embodiment will be described with reference to FIGS. 2 and 3. FIG. 2 schematically illustrates the substrate processing apparatus according to the embodiment. FIG. 3 schematically illustrates a vertical cross-section of the substrate processing apparatus taken along the line α-α′ in FIG. 2.

Referring to FIG. 2 and FIG. 3, the substrate processing apparatus 100 according to the embodiment is capable of processing a wafer (substrate) W. The substrate processing apparatus 100 includes an IO stage 110, an atmospheric transfer chamber 120, a load lock chamber 130, a vacuum transfer chamber 140 and reactor (“RC”) 200a, reactor 200b, reactor 200c and reactor 200d which are collectively or representatively referred to as reactor 200. The substrate processing apparatus 100a through the substrate processing apparatus 100g are representatively or collectively referred to as the substrate processing apparatus 100. The reactor 200a through the reactor 200d may have the same configuration. Hereinafter, the configuration of the substrate processing apparatus 100 will be described in detail. The substrate processing apparatus 100 is arranged such that the IO stage 110 faces the main corridor 503.

<Atmospheric Transfer Chamber and IO Stage>

The IO stage 110 is provided at the front side of the substrate processing apparatus 100. The IO stage 110 may also be referred to as “loading port shelf.” A plurality of pods 111 MAY BE placed on the IO stage 110. The pod 111 is used as a carrier for transferring the wafer W such as a silicon (Si) substrate.

The IO stage 110 is provided adjacent to the atmospheric transfer chamber 120. The load lock chamber 130, which will be described later, is connected to a side of the atmospheric transfer chamber 120 other than the side at which the IO stage 110 is provided. An atmospheric transfer robot 122 configured to transfer the wafer W is provided in the atmospheric transfer chamber 120.

A substrate loading/unloading port 128 and the pod opener 121 for transferring the wafer W into or out of the atmospheric transfer chamber 120 are provided at the front side of a housing 127 of the atmospheric transfer chamber 120. A substrate loading/unloading port 129 for transferring the wafer W into or out of the load lock chamber 130 is provided at the rear side of the housing 127 of the atmospheric transfer chamber 120. The substrate loading/unloading port 129 is opened or closed by a gate valve 133. When the substrate loading/unloading port 129 is opened, the wafer W may be loaded into the load lock chamber 130 or unloaded from the load lock chamber 130. A mount 123 for mounting the mobile terminal 300 is provided on a sidewall of the atmospheric transfer chamber 120. The mobile terminal 300 will be described later in detail.

<Load lock Chamber>

The load lock chamber 130 is provided adjacent to the atmospheric transfer chamber 120. The vacuum transfer chamber 140, which will be described later, is provided at a side of the housing 131 constituting the load lock chamber 130 other than the side of the housing 131 that is adjacent to the atmospheric transfer chamber 120. The load lock chamber 130 is connected to the vacuum transfer chamber 140 via a gate valve 134.

A substrate support 136 having at least two placing surfaces 135, on which the wafer W may be placed, is provided in the load lock chamber 130. The distance between the at least two placing surfaces 135 is set based on the distance between end effectors of the arm of the vacuum transfer robot 170.

<Vacuum Transfer Chamber>

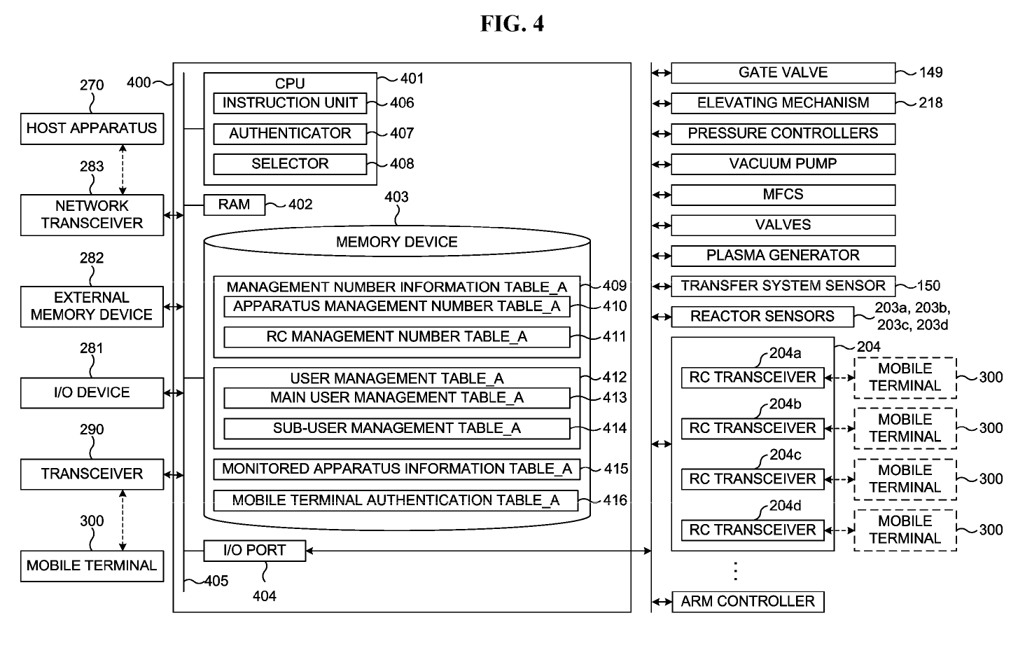

The substrate processing apparatus 100 includes the vacuum transfer chamber (transfer module) 140, that is, a transfer space in which the wafer W is transported under negative pressure. A housing 141 constituting the vacuum transfer chamber 140 is pentagonal when viewed from above. The load lock chamber 130 and the reactors 200a, 200b, 200c and 200d where the wafer W is processed are connected to respective sides of the pentagonal housing 141. The vacuum transfer robot 170 capable of transferring the wafer W under negative pressure is provided at approximately at the center of the vacuum transfer chamber 140 with a flange 144 as a base. While four reactors 200a, 200b, 200c and 200d are shown in FIG. 4, the number of reactors are not limited to four.

The vacuum transfer robot 170 provided in the vacuum transfer chamber 140 may be lifted and lowered by an elevator 145 and the flange 144 while maintaining the vacuum transfer chamber 140 airtight. The vacuum transfer robot 170 may include two arms 180 that may be independently elevated by the elevator 145. Only end effectors of the two arms 180 are illustrated in FIG. 3 and other components of the vacuum transfer robot 170 such as a robot shaft coupled to the flange 144 are omitted for simplification.

The reactors 200a, 200b, 200c and 200d are connected to the vacuum transfer chamber 140 from the outer sidewalls thereof to be radially arranged with respect to the vacuum transfer chamber 140. Substrate loading/unloading ports 148a, 148b, 148c and 148d, which are collectively or representatively referred to as substrate loading/unloading port 148, are provided in the sidewalls of the housing 141 facing the reactors 200a, 200b, 200c and 200d, respectively. For example, the substrate loading/unloading port 148c is provided in the sidewall of the housing 141 facing the reactor 200c as shown in FIG. 3. The reactors 200a, 200b, 200c and 200d are respectively provided with gate valves 149a, 149b, 149c and 149d which are collectively or representatively referred to gate valve 149. For example, the reactor 200c is provided with the gate valve 149c. While the reactor 200c provided with the substrate loading/unloading port 148c and the gate valve 149c are illustrated in FIG. 3, the similar applies to the reactors 200a, 200b and 200d. Therefore, the detailed descriptions of the reactors 200a, 200b and 200d, the substrate loading/unloading ports 148a, 148b and 148d and the gate valves 149a, 149b and 149d are omitted.

Next, the vacuum transfer robot 170 provided in the vacuum transfer chamber 140 will be described. The vacuum transfer robot 170 has two arms 180. The arms 180 have the end effectors for placing the wafer W thereon.

The elevator 145 controls the elevation or rotation of the arms 180. The arms 180 may be rotated and extended around an arm shaft (not shown). By rotating and extending of the arms 180, the wafer W may be loaded into and unloaded from the reactors 200a, 200b, 200c and 200d.

A transfer system sensor 150 detects the states of the atmospheric transfer chamber 120, the load lock chamber 130 and the vacuum transfer chamber 140. The “state” refers to information such as the operation time and temperature of the atmospheric transfer robot 122, the operation time and temperature of the vacuum transfer robot 170. When the temperature of the wafer W in the load lock chamber 130 is managed, the information may include the temperature of the wafer W in the load lock chamber 130. While a single transfer system sensor 150 detects the states of the atmospheric transfer chamber 120, the load lock chamber 130 and the vacuum transfer chamber 140 in FIG. 3, the transfer system sensor 150 may be provided for each of the atmospheric transfer chamber 120, the load lock chamber 130 and the vacuum transfer chamber 140 to detect each state of the atmospheric transfer chamber 120, the load lock chamber 130 and the vacuum transfer chamber 140. The transfer system sensor 150 may be also referred to as “transfer system sensor.” Herein, the atmospheric transfer chamber 120 and the vacuum transfer chamber 140 are collectively referred to as “transfer chamber.”

<Controller>

The substrate processing apparatus 100 includes the controller 400 configured to control the operation of the components of the substrate processing apparatus 100 including the reactors 200a, 200b, 200c and 200d.

FIG. 4 schematically illustrates the configuration of the controller 400. The controller 400, which is a control unit (control means), may be embodied by a computer including a central processing unit (CPU) 401, a random access memory (RAM) 402, a memory device (memory unit) 403 and an I/O port 404. The RAM 402, the memory device 403 and the I/O port 404 are capable of exchanging data with the CPU 401 via an internal bus 405. The data may be exchanged (transmitted or received) in the substrate processing apparatus 100 in accordance with an instruction from a transmission/reception instruction unit 406, which is a function of the CPU 401.

The mobile terminal 300 serving as an input/output device may be wirelessly connected to the controller 400 through a transceiver 290 for mobile terminal. A network transceiver 283 is electrically connected to a host apparatus 270 through a network. The network transceiver 283 is capable of receiving information such as processing history and processing schedule of the wafer W accommodated in the pod 111 from the host apparatus 270.

The memory device 403 is embodied by components such as a flash memory and a hard disk drive (HDD). A control program for controlling the operation of the substrate processing apparatus 100, a process recipe having information such as sequences and conditions of the substrate processing which will be described later, and data tables 409 through 416, which will be described later, are readably stored in the memory device 403. The data tables 409 through 416 will be described later in detail.

The process recipe functions as a program that enables the controller 400 to execute predetermined steps of a substrate processing to obtain a predetermined result. Hereinafter, the process recipe and the control program may also be collectively referred to as “program.” Hereinafter, “program” refers to only the process recipe, only the control program, or both. The RAM 402 functions as a work area in which information such as the program and the data read by the CPU 401 are temporarily stored.

The I/O port 404 is connected to components provided in the semiconductor processing apparatus 100 such as the gate valves 149a, 149b, 149c and 149d, an elevating mechanism 218 provided at the reactor 200, which will be described later, pressure controllers (not shown), pumps, the transfer system sensor 150 and reactor sensors 203a, 203b, 203c and 203d, which will be described later. The reactor sensors 203a, 203b, 203c and 203d are also referred to as “reactor detectors.” The transfer system sensor 150 and the reactor sensors 203a, 203b, 203c and 203d may be collectively referred to as “detector.”

The CPU 401 is configured to read and execute the control program stored in the memory device 403, and read the process recipe in accordance with an instruction such as an operation command inputted from the input/output device 281. The CPU 401 may be configured to control operations according to the process recipe such as opening and closing operations of the gate valve 149, the operation of the vacuum transfer robot 170, the elevating operations of the elevating mechanism 218, the operations of the reactor sensors 203a, 203b, 203c and 203d, the ON/OFF operations of the pumps, the flow rate adjusting operations of mass flow controllers (MFCs) which will be described later, and the operation of valves which will also be described later.

CPU 401 includes the transmission/reception instruction unit 406, a mobile terminal authenticator 407 and an apparatus information selector 408. The mobile terminal authenticator 407 authenticates the mobile terminal 300. The apparatus information selector 408 selects information to be transmitted to the mobile terminal 300. The mobile terminal authenticator 407 and the apparatus information selector 408 may be embodied as a program which is stored in the memory device 403 and executed by CPU 401 after being loaded into RAM 402. That is, the mobile terminal authenticator 407 may be an authentication program.

The controller 400 may be embodied by installing the above-described program on a computer using the external memory device 282 storing the above-described program. The external memory device 282 may be embodied by a magnetic disk such as a hard disk, an optical disk such as a DVD, a magneto-optical disk such as MO and a semiconductor memory such as a USB memory. The method of providing the program to the computer is not limited to the external memory device 282. The program may be directly provided to the computer without using the external memory device 282 by a communication means such as the Internet and a dedicated communication line. The memory device 403 and the external memory device 282 are embodied by a computer-readable recording medium. Hereinafter, the memory device 403 and the external memory device 282 may be collectively referred to simply as “recording medium.” Herein, the term “recording medium” may refer to only the memory device 403, only the external memory device 282, or both.

(3) Reactor

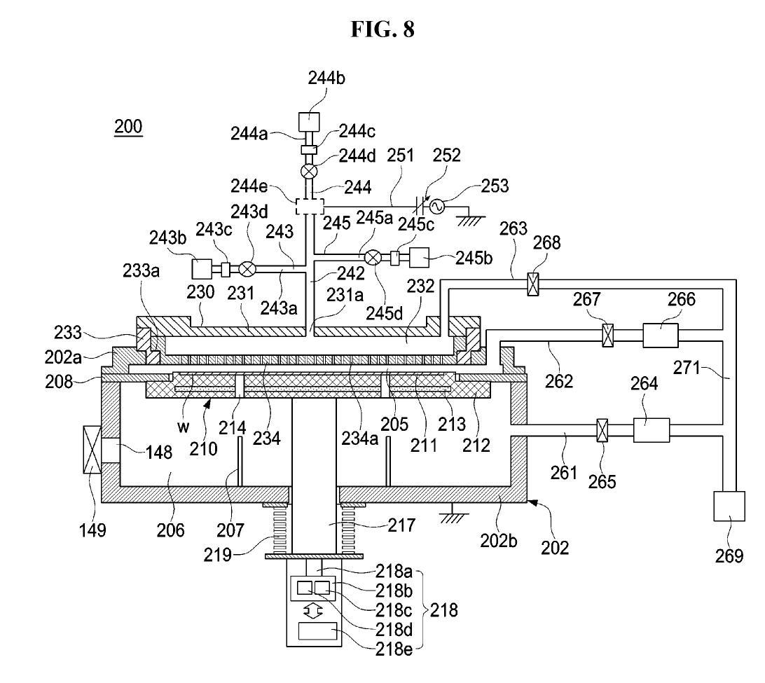

Hereinafter, the reactor 200 will be described with reference to FIGS. 1, 4 and 8. FIG. 8 schematically illustrates the reactor 200 of the substrate processing apparatus 100 according to the embodiment.

As shown in FIG. 2, mounts 201a, 201b, 201c and 201d where the mobile terminals 300 are mounted are provided on the outer walls of the reactors 200a, 200b, 200c and 200d. That is, the mounts 201a, 201b, 201c and 201d are provided on the outer walls of the reactors 200a, 200b, 200c and 200d, respectively. For example, mount 201a is provided on the outer wall of the reactor 200a, mount 201b is provided on the outer wall of the reactor 200b, mount 201c is provided on the outer wall of the reactor 200c, and mount 201d is provided on the outer wall of the reactor 200d.

Reactor sensors 203a, 203b, 203c and 203d are provided at the reactors 200a, 200b, 200c and 200d, respectively. That is, the reactor sensor 203a is provided at the reactor 200a, the reactor sensor 203b is provided at the reactor 200b, the reactor sensor 203c is provided at the reactor 200c, and the reactor sensor 203d is provided at the reactor 200d. The reactor sensors 203a, 203b, 203c and 203d detect the states of the reactors 200a, 200b, 200c and 200d, respectively, and generates state data representing the states of the reactors 200a, 200b, 200c and 200d. The state data representing the states of the reactors 200a, 200b, 200c and 200d are transmitted to the controller 400.

<Vessel>

Next, the representative reactor 200c will be described in detail with reference to FIG. 8. Since the reactors 200a, 200b, 200c and 200d have substantially the same constitution, the detailed descriptions of the reactors 200a, 200b and 200d are omitted.

As shown in FIG. 8, the reactor 200 includes a vessel 202 which is a flat, sealed container having a circular horizontal cross-section. The vessel 202 is made of a metal such as aluminum (Al) and stainless steel (SUS). A processing space 205 where the wafer W is processed and a transfer space 206 through which the wafer W is transported into the processing space 205 are provided in the vessel 202. The vessel 202 includes an upper vessel 202a and a lower vessel 202b. A partition plate 208 is provided between the upper vessel 202a and the lower vessel 202b.

The substrate loading/unloading port 148 is provided on a side surface of the lower vessel 202b adjacent to the gate valve 149. The wafer W is transported between the vacuum transfer chamber 140 and the reactor 200 through the substrate loading/unloading port 148. For example, the reactor 200c is provided with the substrate loading/unloading port 148c and the gate valve 149c. Lift pins 207 are provided at the bottom of the lower vessel 202b. The lower vessel 202b is electrically grounded.

A substrate support 210 capable of supporting the wafer W is provided in the processing space 205. The substrate support 210 includes a substrate support member 212 having a substrate placing surface 211 on which the wafer W is placed and a heater (heating source) 213 provided in the substrate support member 212. Through-holes 214 penetrated by the lift pins 207 are provided at the substrate support member 212 corresponding to the locations of the lift pins 207.

The substrate support member 212 is supported by a shaft 217. The shaft 217 penetrates the bottom of the vessel 202. The shaft 217 is coupled to the elevating mechanism 218 outside the vessel 202.

The elevating mechanism 218 includes a support shaft 218a supporting the shaft 217 and an actuator 218b configured to lift or rotate the support shaft 218a. The actuator 218b may include a lift mechanism 218c such as a motor configured to lift the support shaft 218a and a rotating mechanism 218d such as a gear configured to rotate the support shaft 218a.

The elevating mechanism 218 may further include an instruction unit 218e which is a part of the elevating mechanism 218 and configured to control the actuation unit 218b to move the support shaft 218a up and down or to rotate the support shaft 218a. The instruction unit 218e may be electrically connected to the controller 400. The actuation unit 218b may be controlled by the instruction unit 218e based on an instruction from the controller 400.

The wafer W placed on the substrate placing surface 211 is lifted and lowered by operating the elevating mechanism 218 by way of lifting and lowering the shaft 217 and the substrate support member 212. Bellows 219 covers the periphery of the lower end of the shaft 217. The interior of the processing space 205 is maintained airtight.

When the wafer W is transferred, the substrate support member 212 is moved downward until the substrate placing surface 211 faces the substrate loading/unloading port 148. When the wafer W is processed, the substrate support member 212 is moved upward until the wafer W reaches a processing position in the processing space 205 as shown in FIG. 8.

A shower head 230, which is a gas dispersion mechanism, is provided at an upstream side of the processing space 205. A gas introduction port 231a is provided at a cover 231 of the shower head 230. The gas introduction port 231a communicates with a gas supply pipe 242 which is described later.

The shower head 230 includes a dispersion plate (dispersion mechanism) 234 for dispersing gas. A space at the upstream side of the dispersion plate 234 is referred to as “buffer space 232” and a space at the downstream side of the dispersion plate 234 is referred to as “processing space 205.” The dispersion plate 234 is provided with through-holes 234a. The dispersion plate 234 is disposed to face the substrate placing surface 211. The dispersion plate 234 is, for example, disk-shaped. Through-holes 234a are provided on the entirety of the surface of the dispersion plate 234.

The upper vessel 202a includes a flange (not shown). A support block 233 is placed on and fixed to the flange. The support block 233 includes a flange 233a. The dispersion plate 234 is placed on and fixed to the flange 233a. The cover 231 is fixed to the upper surface of the support block 233.

<Supply System>

The common gas supply pipe 242 is connected to the cover 231 to communicate with the gas introduction port 231a provided in the cover 231 of the shower head 230.

A first gas supply pipe 243a, a second gas supply pipe 244a and a third gas supply pipe 245a are connected to the common gas supply pipe 242.

<First Gas Supply System>

A first gas source 243b, a mass flow controller (MFC) 243c which is a flow rate controller (flow rate control mechanism) and a valve 243d which is an opening/closing valve are provided at the first gas supply pipe 243a in order from the upstream side to the downstream side of the first gas supply pipe 243a.

The first gas source 243b is the source of a first gas containing a first element. The first gas containing the first element is also referred to as “first element-containing gas.” The first element-containing gas is a source gas, i.e. one of process gases. According to the embodiment, the first element may include silicon (Si). That is, the first element-containing gas may include a silicon-containing gas. Specifically, gas such as hexachlorodisilane (Si₂Cl₆, also referred to as HCD) gas may be used as the silicon-containing gas.

A first gas supply system 243 (also referred to as a silicon-containing gas supply system) is constituted by the first gas supply pipe 243a, the mass flow controller 243c and the valve 243d.

<Second Gas Supply System>

A second gas source 244b, a mass flow controller (MFC) 244c which is a flow rate controller (flow rate control mechanism) and a valve 244d which is an opening/closing valve are provided at the second gas supply pipe 244a in order from the upstream side to the downstream side of the second gas supply pipe 244a.

The second gas source 244b is the source of a second gas containing a second element. The second gas containing the second element is also referred to as “second element-containing gas.” The second element-containing gas is one of the process gases. The second element-containing gas may act as a reactive gas or a modifying gas.

According to the embodiment, the second element-containing gas includes the second element different from the first element. The second element-containing gas may include one of oxygen (O), nitrogen (N) and carbon (C). According to the embodiment, the second element-containing gas may include an oxygen-containing gas. Specifically, oxygen (O₂) gas may be used as the oxygen-containing gas.

A remote plasma mechanism 244e may be provided at the second gas supply pipe 244a to process the wafer W with the second gas in plasma state.

A wiring 251 is connected to the remote plasma mechanism 244e. The power supply 253 is provided on the upstream side of the wiring 251. A frequency matching mechanism 252 is provided between the remote plasma mechanism 244e and the power supply 253. Plasma is generated by the remote plasma mechanism 244e by adjusting the matching parameter by the frequency matching mechanism 252 while power is supplied from the power supply 253. According to the embodiment, the remote plasma mechanism 244e. the wiring 251 and the frequency matching mechanism 252 constitute a plasma generator. The plasma generator may further include the power supply 253.

The second gas supply system 244 (also referred to as a reactive gas supply system) is constituted by the second gas supply pipe 244a, the mass flow controller 244c and the valve 244d. The second gas supply system 244 may further include the remote plasma mechanism 244e.

<Third Gas Supply System>

A third gas source 245b, a mass flow controller (MFC) 245c which is a flow rate controller (flow rate control mechanism) and a valve 245d which is an opening/closing valve are provided at the third gas supply pipe 245a in order from the upstream side to the downstream side of the third gas supply pipe 245a.

The third gas source 245b is the source of an inert gas. For example, the inert gas includes nitrogen (N₂).

The third gas supply system 245 is constituted by the third gas supply pipe 245a, the mass flow controller 245c and the valve 245d.

The inert gas supplied from the third gas source 245b serves as a purge gas for purging the gas present in the vessel 202 or in the shower head 230 during the substrate processing.

<Exhaust System>

The exhaust system for exhausting the inner atmosphere of the vessel 202 includes a plurality of exhaust pipes connected to the vessel 202. Specifically, the exhaust system includes an exhaust pipe (first exhaust pipe) 263 connected to the buffer space 232, an exhaust pipe (second exhaust pipe) 262 connected to the processing space 205 and an exhaust pipe (third exhaust pipe) 261 connected to the transfer space 206. An exhaust pipe (fourth exhaust pipe) 271 is connected to the exhaust pipes 263, 262 and 261 at the downstream sides of the exhaust pipes 263, 262 and 261.

The exhaust pipe 261 is connected to the lower vessel 202b so as to communicate with the transfer space 206. A pump (Turbo Molecular Pump, TMP) 264 is provided at the exhaust pipe 261. A valve 265, which is an exhaust valve for exhausting the transfer space 206, is provided at the upstream sides of the pump 264 at the exhaust pipe 261.

The exhaust pipe 262 is connected to the upper vessel 202a so as to communicate with the processing space 205. An APC (Automatic Pressure Controller) 266, which is a pressure controller for adjusting the inner pressure of the processing space 205 to a predetermined pressure, is provided at the exhaust pipe 262. The APC 266 includes a valve body (not shown) capable of adjusting the degree of opening. The APC 266 adjusts the conductance of the exhaust pipe 262 in accordance with an instruction from the controller 400. A valve 267 is provided on the upstream side of the APC 266 at the exhaust pipe 262. Herein, the exhaust pipe 262, the valve 267 ant the APC 266 are collectively referred to as “process chamber exhaust system.”

The exhaust pipe 263 is connected to the cover 231 so as to communicate with the buffer space 232. A valve 268 is provided at the exhaust pipe 263. Herein, the exhaust pipe 263 and the valve 268 are collectively referred to as “shower head exhaust system.”

A dry pump (DP) 269 is provided at the exhaust pipe 271. As shown in FIG. 8, the exhaust pipes 263, 262 and 261 are connected to the upstream side of the exhaust pipe 271 and the dry pump 269 is provided at the downstream side of the location where the exhaust pipes 263, 262 and 261 are connected to the exhaust pipe 271. The DP 269 exhausts the atmospheres of the buffer space 232, the processing space 205 and the transfer space 206 through the exhaust pipe 262, the exhaust pipe 263 and the exhaust pipe 261, respectively. When the TMP 264 is operated, the DP 269 may serve as an auxiliary pump for the TMP 264. That is, The DP 269 is capable of assisting the exhaust of the inner atmosphere for the TMP 264 when the TMP 264 exhausts the inner atmosphere to obtain high vacuum (or ultra-high vacuum). An air valve may be used as the valves of exhaust system.

<RC Transceiver>

As shown in FIG. 4, an RC transceiver 204 is provided for the reactors 200a, 200b, 200c and 200d. Specifically, an RC transceiver 204a, an RC transceiver 204b, an RC transceiver 204c and an RC transceiver 204d are provided for the reactor 200a, the reactor 200b, the reactor 200c, and the reactor 200d, respectively. The RC transceivers 204a, 204b, 204c and 204d may be electrically connected to the mobile terminal 300.

When the mobile terminal 300 requests information, the RC transceiver 204 transmits the state data generated by the reactor sensors 203a, 203b, 203c and 203d or the management numbers of the reactors 200a, 200b, 200c and 200d to the mobile terminal 300. For example, when the mobile terminal 300 requests information to the RC transceiver 204c, the RC transceiver 204c transmits the management number or operating information of the reactor 200c to the mobile terminal 300.

(4) Data tables stored in the substrate processing apparatus 100

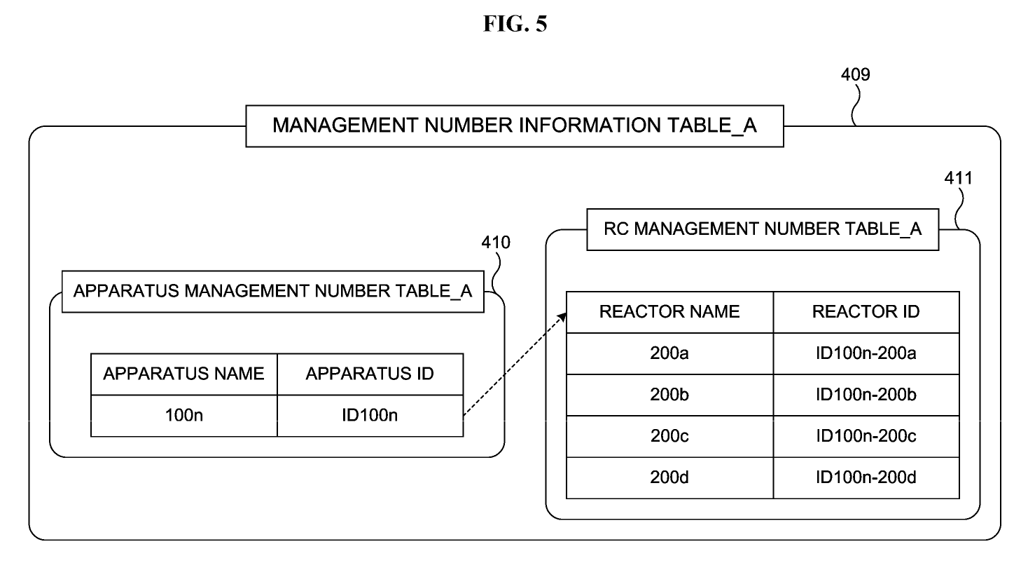

Next, the data tables stored in the memory device 403 will be described with reference to FIGS. 5, 6, 7 and 9. Hereinafter, the data table may also be referred to as “table.” Among the tables described herein, the table having the name that ends with “_A” is a table stored in an “A”pparatus, i.e. in the substrate processing apparatus 100.

<Management Number Information Table_A>

A management number information table_A 409 will be described with reference to FIG. 5. The management number information table_A 409 includes an apparatus management number table_A 410 and an RC management number table_A 411.

The apparatus management number table_A 410 contains the name of the substrate processing apparatus and associated substrate processing apparatus ID (also referred to as apparatus management number). For example, if the name of the substrate processing apparatus is “100n”, the substrate processing apparatus ID may be “ID100n”. The RC management number table_A 411 stores the reactor name and the reactor ID. For example, 200a and ID100n-200a may be stored as the reactor name and the reactor ID of the reactor 200a of the substrate processing apparatus 100n, respectively, and 200b and ID100n-200b may be stored as the reactor name and the reactor ID of the reactor 200b of the substrate processing apparatus 100n, respectively. The reactors 200a, 200b, 200c and 200d can be distinguished by the RC management number table_A 411.

The apparatus management number and monitored apparatus information which will be described later are collectively referred to “apparatus information.”

<User Management Table_A>

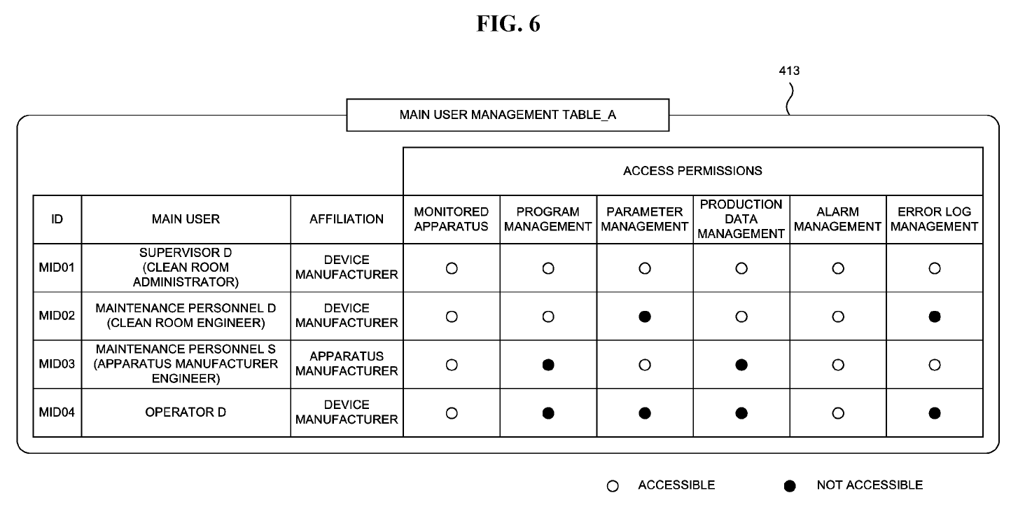

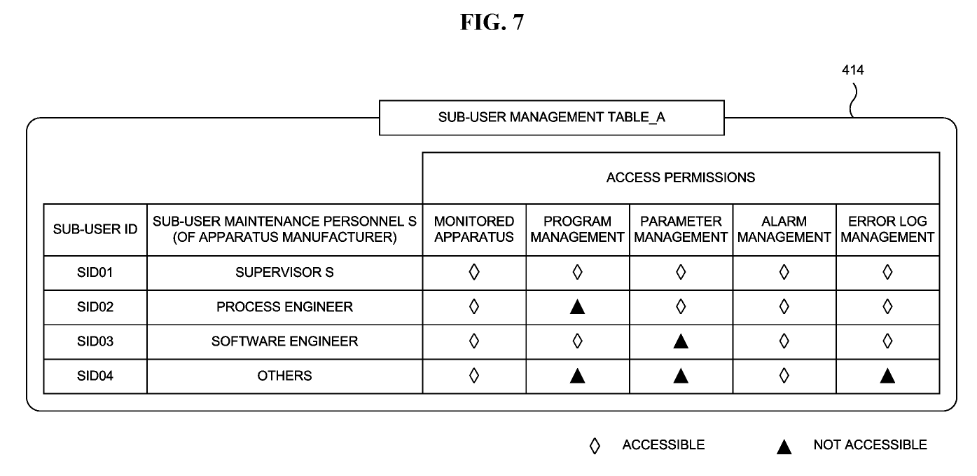

Next, a user management table_A will be described with reference to FIGS. 6 and 7. The user management table_A includes a main user management table_A 413 and a sub-user management table_A 414.

The main user management table_A 413 will be described with reference to FIG. 6. As described above, various administrators may manage the substrate processing apparatus. The main user management table_A 413 is for managing access permissions of the administrators. The main user management table_A 413 includes information on main users. According to embodiment, the main user includes “SUPERVISOR D” (clean room administrator), “MAINTENANCE PERSONNEL D” (clean room engineer), “MAINTENANCE PERSONNEL S” (engineer working for the substrate processing apparatus manufacturer) and “OPERATOR D.” ID, affiliation and access permission of each main user are stored in the main user management table_A 413 as shown in FIG. 6. “ACCESS PERMISSION” field shown in FIG. 6 defines the access permissions of each main user. Specifically, “∘” denotes accessible the information, and “●” denotes non-accessible the information.

Specifically, referring to FIG. 6, “SUPERVISOR D” is a clean room administrator affiliated with device manufacturer, and is able to access and modify all information (from “monitored apparatus information” to “error log management”). “MAINTENANCE PERSONNEL S” is affiliated with the substrate processing apparatus manufacturer, and is able to access only “monitored apparatus information” and “alarm management.” In FIG. 6, the main user ending with “D” indicates that the main user is affiliated with the device manufacturer, and the main user ending with “S” indicates that the main user is affiliated with the substrate processing apparatus manufacturer.

<Sub-User Management Table_A>

A sub-user management table_A 414 will be described with reference to FIG. “Sub-user” is a further subdivision of the main user. The sub-user management table_A 414 is for defining: sub-user IDs to be received from the mobile terminal 300 and information allowed (and not allowed) to be transmitted to the mobile terminal 300. Specifically, the sub-user management table_A 414 includes sub-user IDs and the information that is allowed (or not allowed) to be transmitted depending on the access rights of the sub-user IDs.

As shown in FIG. 7, “SUPERVISOR S”, “PROCESS ENGINEER”, “SOFTWARE ENGINEER” and “OTHERS” are displayed as sub-users of the main user “MAINTENANCE PERSONNEL S”. Each sub-users is assigned an ID, i.e., a sub-user ID.

“SUPERVISOR S” is a sub-user affiliated with the substrate processing apparatus manufacturer, and inherits the access permission of the main user “MAINTENANCE PERSONNEL S” such that “SUPERVISOR S” is able to access and modify all information via the mobile terminal 300. “PROCESS ENGINEER” is a sub-user for a maintenance personnel who performs maintenance of the parts necessary for processing the substrates, and is granted access to “MONITORED APPARATUS INFORMATION”, “PARAMETER MANAGEMENT”, “ALARM MANAGEMENT” and “ERROR LOG MANAGEMENT” via the mobile terminal 300. “SOFTWARE ENGINEER” is a sub-user for a maintenance personnel who performs maintenance of software, and is granted access to “MONITORED APPARATUS INFORMATION”, “PROGRAM MANAGEMENT”, “ALARM MANAGEMENT” and “ERROR LOG MANAGEMENT” via the mobile terminal 300. “OTHERS” is a sub-user for the administrators affiliated with the manufacturers of the parts used in the substrate processing apparatus 100. The administrators affiliated with the manufacturers of the parts used in the substrate processing apparatus 100 is granted access to only “MONITORED APPARATUS INFORMATION” and “ALARM MANAGEMENT” via the mobile terminal 300 such that excessive information is not provided.

<Monitored Apparatus information Table>

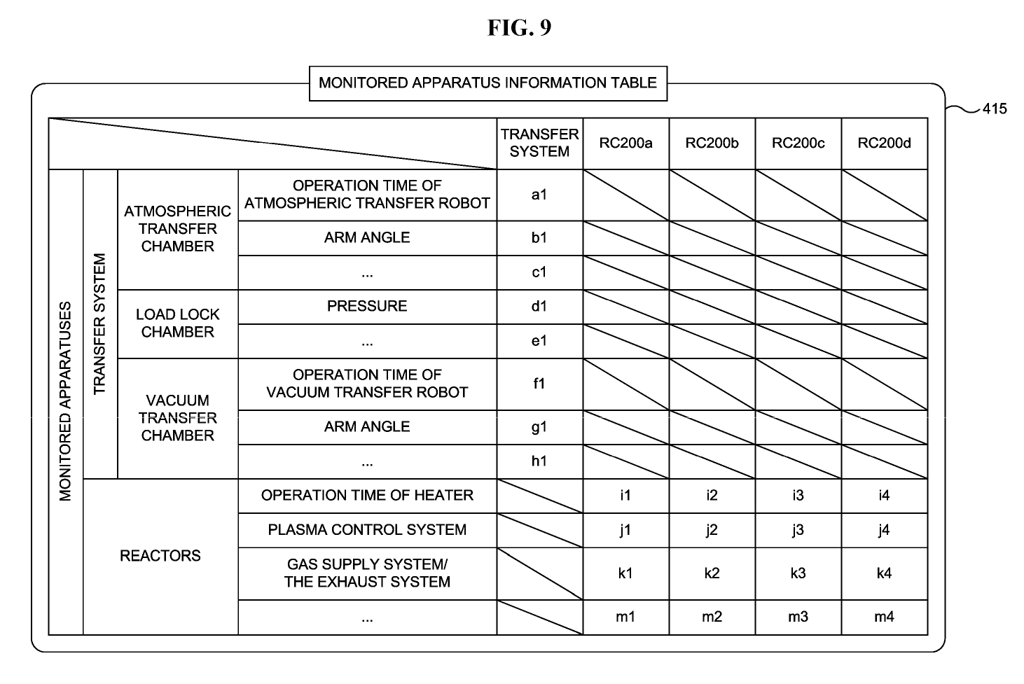

A monitored apparatus information table 415 will be described with reference to FIG. 9. FIG. 9 illustrates the table 415 defining monitored apparatus information. Referring to FIG. 9, information on the components to be monitored of the substrate processing apparatus to be monitored is listed in the apparatus information table 415. The components to be monitored include the transfer system (denoted as “TRANSFER SYSTEM INFORMATION”) and the reactors (denoted as “REACTOR INFORMATION”). “TRANSFER SYSTEM INFORMATION” includes information on the atmospheric transfer chamber 120, the load lock chamber 130 and the vacuum transfer chamber 140. “REACTOR INFORMATION” includes information on the reactors 200a, 200b, 200c and 200d.

Next, the monitored apparatus information will be described by way of an example including the monitored apparatus information of the reactor 200a, 200b, 200c and 200d. The monitored apparatus information includes: information on the parts constituting the plasma generator (denoted as “PLASMA CONTROL SYSTEM” in FIG. 9) such as the cumulative operation time of the frequency matching mechanism 252, for example; and information on the parts constituting the gas supply system or the exhaust system (denoted as “GAS SUPPLY SYSTEM/THE EXHAUST SYSTEM” in FIG. 9) such as operation time and opening degree of a valve. The monitored apparatus information of the reactor is detected in real time by the reactor sensors 203a, 203b, 203c and 203d. The values detected by the reactor sensors 203a, 203b, 203c and 203d are stored as data i1-i4, j1-j4, k1-k4 and m1-m4 in the data table. Specifically, the plasma generator is monitored and the state of the plasma generator is detected by the reactor sensor 203a, and the detected value is transmitted to the controller 400. The controller 400 then stores the received value as the data j1 in the table. Similarly, the values detected by the transfer system sensor 150 in the transfer system are stored as the data a1-h1 in the data table. For example, the operation time and the arm angle of the vacuum transfer chamber 140 are acquired and stored as the data f1-h1 in the table.

(5) Mobile Terminal

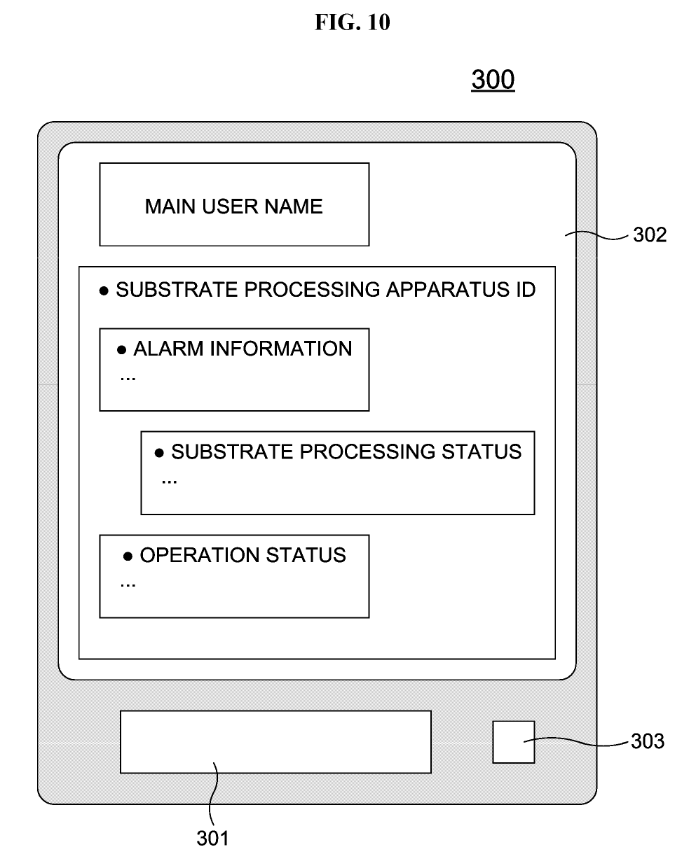

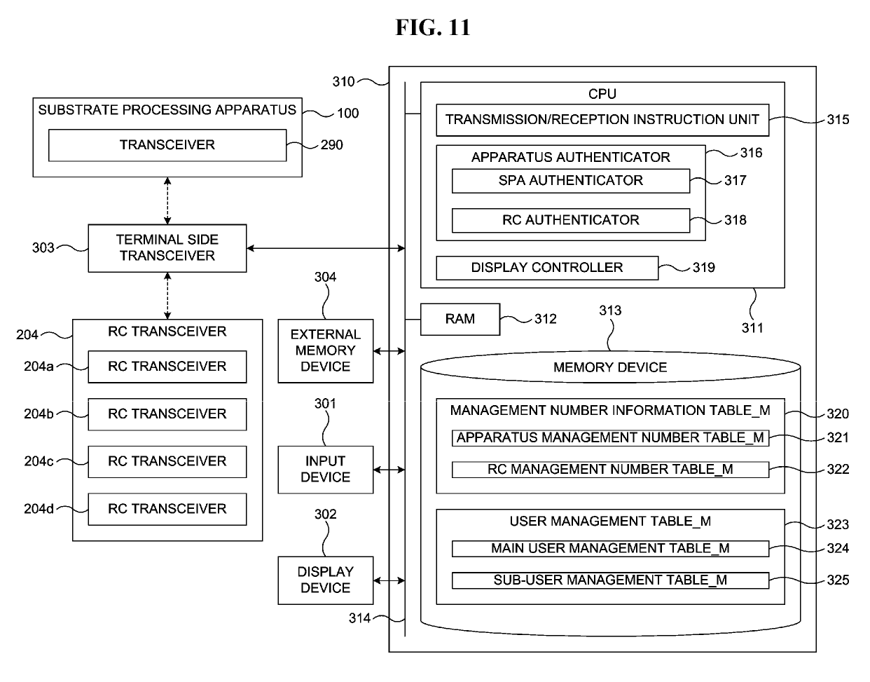

Next, the mobile terminal 300 will be described with reference to FIGS. 10, 11, 12 and 13. The mobile terminal 300 can be carried by an administrator and includes, for example, a tablet computer. As shown in FIG. 10, the mobile terminal 300 includes an input device 301, a display device 302, and a terminal side transceiver 303. The mobile terminal 300 further includes the controller 310 shown in FIG. 11. The display device 302 may be equipped with a touch panel which has the same capability as the input device 301. The mobile terminal 300 may further include a port (not shown) for connecting an external memory such as a USB memory.

Herein, the transceiver 290, the terminal side transceiver 303 and the network transceiver 283 may also be referred to as “first transceiver”, “second transceiver” and “third transceiver”, respectively.

The display device 302 is capable of displaying the management number and the name of the substrate processing apparatus 100. The display device 302 is also capable of displaying main user, sub-user and apparatus information such as alarm information, substrate processing status and operation status of the substrate processing apparatus 100 linked to the displayed user. The management number of the substrate processing apparatus displayed on display device 302 is stored in the “APPARATUS ID” field of the apparatus management number table_A 410 shown in FIG. 5. The alarm information displayed on the display device 302 indicates whether an alarm for warning a malfunction of the apparatus has been triggered. The substrate processing status displayed on the display device 302 indicates whether a substrate is currently being processed or not.

The display device 302 is capable of hierarchically displaying the operation status of the substrate processing apparatus 100. For example, the display device 302 may be configured to display information on “supply system”, “first gas supply system”, “mass flow controller” and operation time in turn to show which component is in operation. The display device 302 may be further configured to display more detailed information for the user when one of the components is selected.

The terminal side transceiver 303 is capable of transmitting and receiving data to and from the transceiver 290 of the substrate processing apparatus 100 and the RC transceiver 204 of the RC 200 including the RC transceiver 204a of the RC 200a, the RC transceiver 204b of the RC 200b, the RC transceiver 204c of the RC 200c and the RC transceiver 204d of the RC 200d.

<Controller>

Next, the controller 310 of the mobile terminal 300 will be described with reference to the FIG. 11. The mobile terminal 300 includes the controller 310 configured to control the operation of the components of the mobile terminal 300.

The controller 310 which is a control apparatus (control means) may be embodied by a computer including a central processing unit (CPU) 311, a random access memory (RAM) 312 and a memory device (memory unit) 313. The RAM 312 and the memory device 313 can exchange data with the CPU 311 via an internal bus 314.

Next, the CPU 311 will be described. The transmission/reception instruction unit 315 directs the terminal side transceiver 303 to transmit and receive data to and from the substrate processing apparatuses 100 (or the reactors 200a, 200b, 200c and 200d). An apparatus authenticator 316 determines whether the substrate processing apparatus 100 or the reactors 200a, 200b, 200c and 200d to which the mobile terminal 300 is connected is apparatus to be managed. The apparatus authenticator 316 includes a substrate processing apparatus authenticator (SPA authenticator) 317 and a reactor authenticator 318. The display controller 319 controls the display device 302. The apparatus authenticator 316 may be configured to perform authentication by an authentication program. The authentication program may be stored in the memory device 313 and temporarily stored in the RAM 312 when executed to implement the functionality of the apparatus authenticator 316. When the authentication program is employed to implement the functionality of the apparatus authenticator 316, the CPU 311 may be embodied by a general-purpose CPU that is capable of executing the authentication program.

The controller 310 is electrically connected to the substrate processing apparatus 100 and the reactors 200a, 200b, 200c and 200d via the terminal side transceiver 303. An external memory device 304 may be connected to the controller 310.

The memory device 313 is embodied by components such as a flash memory and a hard disk drive (HDD). A control program for controlling the operation of the mobile terminal 300 and data tables 320 through 325 which will be described later are readably stored in the memory device 313.

The apparatus authenticator 316 of the CPU 311 includes the substrate processing apparatus authenticator 317 and the RC authenticator 318. The substrate processing apparatus authenticator 317 receives the substrate processing apparatus ID from the substrate processing apparatus 100 and determines whether the substrate processing apparatus 100 is apparatus to be managed based on the substrate processing apparatus ID. The substrate processing apparatus authenticator 317 compares the received substrate processing apparatus ID with the apparatus management number table_M 321 as described below, and if the received substrate processing apparatus ID exists in the apparatus management number table_M 321, the substrate processing apparatus 100 is regarded as apparatus to be managed.

The RC authenticator 318 receives the reactor management number (also referred to as “reactor ID”) from the reactor 200 (reactors 200a, 200b, 200c and 200d) and determines whether the reactor 200 is apparatus to be managed based on the reactor ID. The RC authenticator 318 compares the received reactor ID with the RC management number table_M (322), and if the received reactor ID exists in the RC management number table_M 322, the corresponding reactor is regarded as apparatus to be managed.

The controller 310 may be embodied by installing the above-described program on a computer using the external memory device 304 storing the above-described program. The external memory device 304 may be embodied by a magnetic disk such as a hard disk, an optical disk such as a DVD, a magneto-optical disk such as MO and a semiconductor memory such as a USB memory. The method of providing the program to the computer is not limited to the external memory device 304. The program may be directly provided to the computer by a communication means such as the Internet and a dedicated line without using the external memory device 304. The memory device 313 and the external memory device 304 are embodied by a computer-readable recording medium. Hereinafter, the memory device 313 and the external memory device 304 may be collectively referred to simply as “recording medium.” Herein, the term “recording medium” may refer to only the memory device 313, only the external memory device 304, or both.

(6) Data Tables Stored in the Mobile Terminal 300

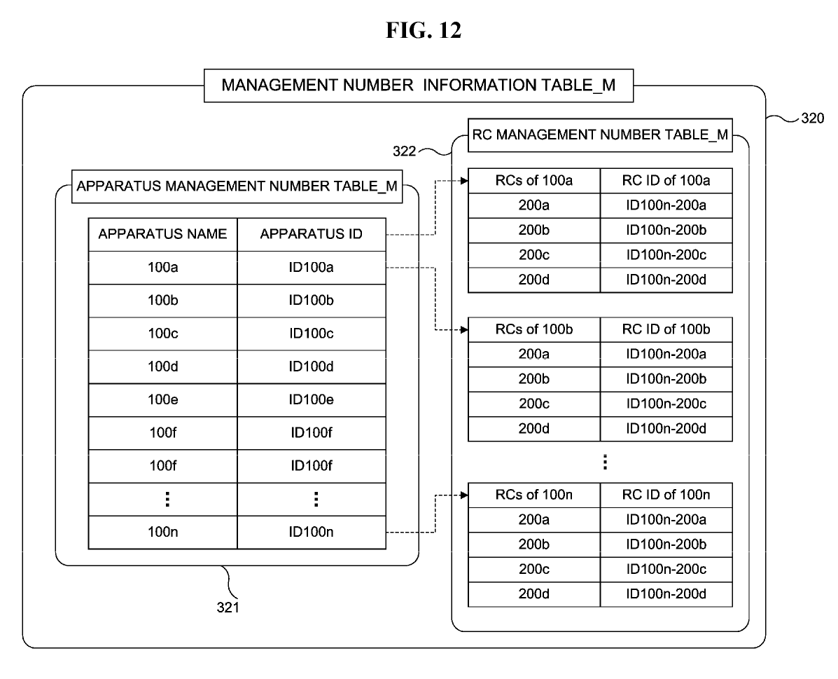

Next, the data tables stored in the memory device 313 of the mobile terminal 300 will be described with reference to FIGS. 12, 13 and 14. The table having the name that ends with “_M” is a table stored in a “M”obile terminal, i.e. in the mobile terminal 300.

<Management Number Information Table_M>

A management number information table_M 320 will be described with reference to FIG. 12. The management number information table_M 320 includes an apparatus management number table_M 321 and an RC management number table_M 322.

The apparatus management number table_M 321 contains the name of the substrate processing apparatus and associated management number (substrate processing apparatus ID). The RC management number table_M 322 contains the name of the reactor and associated RC management number (reactor ID). Since the mobile terminal 300 is used to manages multiple substrate processing apparatuses including the substrate processing apparatuses 100a, 100b, 100c and 100d, the information of the multiple substrate processing apparatuses is stored in the management number information table M 320.

<User Management Table_M>

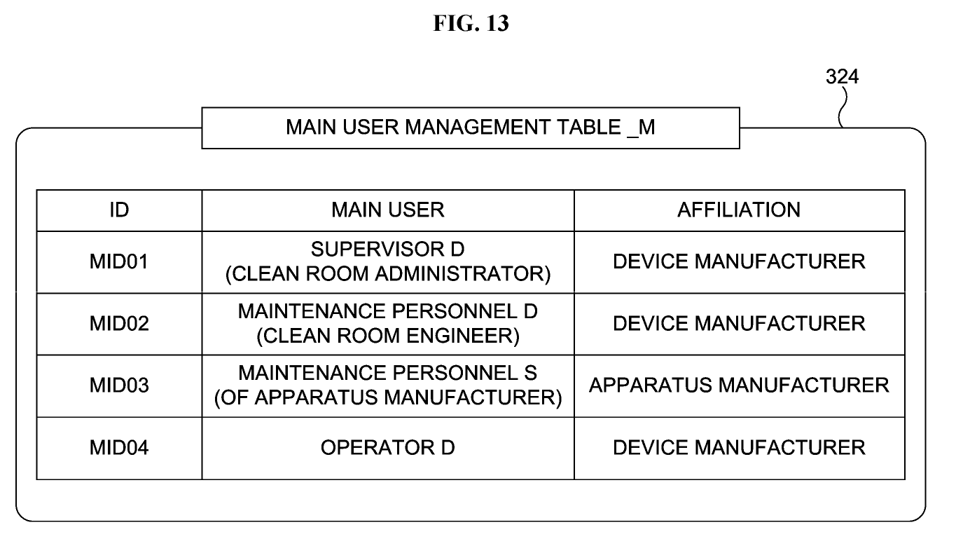

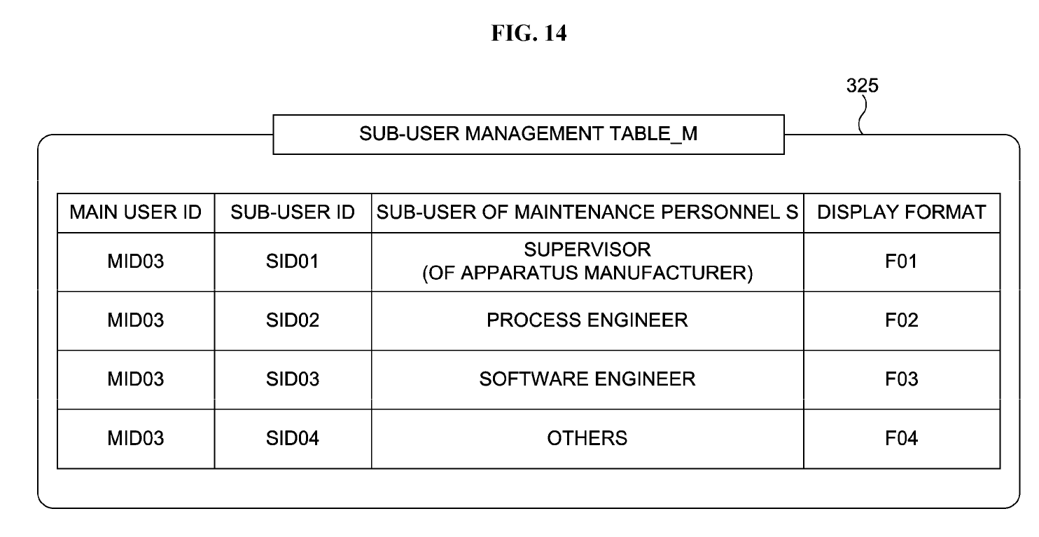

Hereinafter, a user management table_M 323 will be described with reference to FIGS. 13 and 14. The user management table_M 323 includes a main user management table_M 324 and a sub-user management table_M 325.

<Main User Management Table_M>

The main user management table_M 324 will be described with reference to FIG. 13. As described above, the substrate processing apparatus is managed by various administrators. The mobile terminal 300 may be configured to display different information for each administrator. The main user management table_M 324 is for managing administrators. The main user management table_M 324 stores the main user, ID and affiliation. The main user is substantially the same as that of the main user management table_A 413 described above. The main user includes, for example, “SUPERVISOR D” (clean room administrator), “MAINTENANCE PERSONNEL D” (clean room engineer), “MAINTENANCE PERSONNEL S” (engineer of the substrate processing apparatus manufacturer) and “OPERATOR D.”

<Sub-User Management Table_M>

The sub-user management table_M 325 will be described with reference to FIG. 14. The sub-user management table_M 325 contains main user ID, sub-user ID, sub-user and display format information. The sub-user of the main user MID03 (“MAINTENANCE PERSONNEL S”) includes, for example, “SUPERVISOR S”, “PROCESS ENGINEER”, “SOFTWARE ENGINEER” and “OTHERS.”

The sub-user is grated access to the information contained in the sub-user management table_A 414 shown in FIG. 7 via the mobile terminal 300. “SUPERVISOR S” is a sub-user affiliated with the substrate processing apparatus manufacturer. Specifically, “SUPERVISOR S” has access to all information via the mobile terminal 300 by inheriting the access permission of “MAINTENANCE PERSONNEL S.” “PROCESS ENGINEER” is a sub-user for a maintenance personnel who performs maintenance the parts for processing the substrate, and is granted access to “MONITORED APPARATUS INFORMATION”, “PARAMETER MANAGEMENT”, “ALARM MANAGEMENT” and “ERROR LOG MANAGEMENT” via the mobile terminal 300. “SOFTWARE ENGINEER” is a sub-user for a maintenance personnel who performs maintenance of software, and is granted access to “MONITORED APPARATUS INFORMATION”, “PROGRAM MANAGEMENT”, “ALARM MANAGEMENT” and “ERROR LOG MANAGEMENT” via the mobile terminal 300.

As an example, FIG. 14 illustrates the sub-user management table_M 325 containing the sub-users of the main user “MAINTENANCE PERSONNEL S.” The field “DISPLAY FORMAT” defines the display format of the apparatus information for each sub-user when the apparatus information is displayed on the display device 302. In case where the administrator affiliated with the device manufacturer uses the mobile terminal 300, the sub-user management table_A 414 may contain the sub-users of “SUPERVISOR D”, “MAINTENANCE PERSONNEL D” or “OPERATOR D”, for example.

That is, while the sub-user management table_A 414 is described by way of exemplifying the sub-users of “MAINTENANCE PERSONNEL S”, the sub-user management table_A 414 may also be created for the sub-users of different main users.

(7) Substrate Processing

Hereinafter, the substrate processing for forming a film on the wafer W using the reactor 200 will be described as one of the processes for manufacturing a semiconductor device. In the following descriptions, the operations of the components constituting the substrate processing apparatus 100 are controlled by the controller 400.

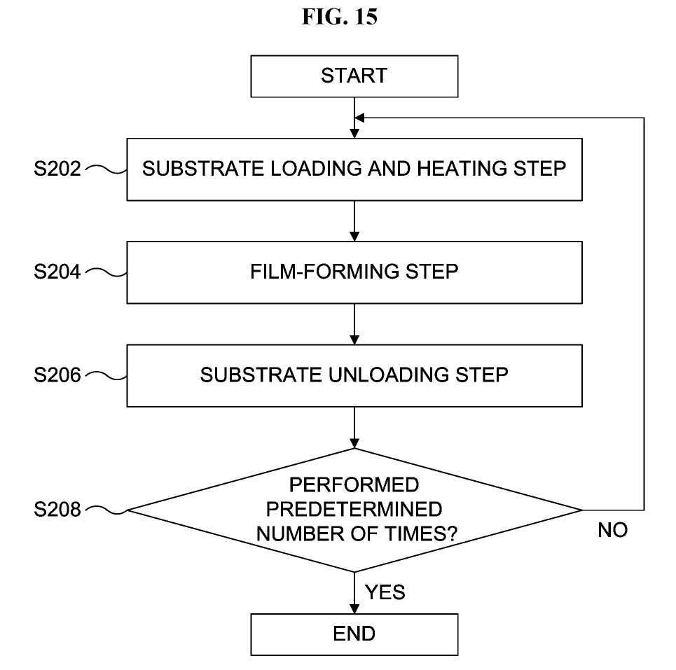

The substrate processing will be described with reference to the FIG. 15 by way of an example wherein a silicon oxide (SiO) film is formed on the wafer W by alternately supplying HCD gas obtained by vaporizing HCD as the first element-containing gas (first process gas) and O₂ gas as the second element-containing gas (second process gas).

<Substrate Loading and Heating Step S202>

Hereinafter, a substrate loading and heating Step S202 will be described. After the wafer W is transferred into the vessel 202, the vacuum transfer robot 170 is retracted to the outside of the vessel 202, and the gate valve 149 is closed to seal the vessel 202. Thereafter, by elevating the substrate support member 212, the wafer W is placed on the substrate placing surface 211 on the substrate support member 212. By further elevating the substrate support member 212, the wafer W is elevated to a position for processing the wafer W (substrate processing position) in the processing space 205 described above.

After the wafer W is elevated, the inner pressure of the processing space 205 is controlled to a predetermined pressure, and the temperature of the surface of the wafer W is controlled to a predetermined temperature. The temperature of the surface of the wafer W ranges, for example, from room temperature to 500° C., preferably from room temperature to 400° C. The inner pressure of the processing space 205 ranges, for example, from 50 Pa to 5,000 Pa.

<Film-Forming Step S204>

Hereinafter, a film-forming step S204 will be described. After the substrate loading and heating Step S202 is completed, the film-forming step S204 is performed. In the film-forming step S204, a film is formed according to the process recipe by controlling the first gas supply system to supply the first gas into the processing space 205 and the exhaust system to exhaust the processing space 205. In the film-forming step S204, the second gas supply system may be further controlled to: supply the second gas into the processing space 205 simultaneously with the first gas to perform CVD process or to alternately supply the first gas and the second gas. The remote plasma mechanism 244e may be activated to activate the second gas into plasma state.

When the first gas and the second gas are alternately supplied, HCD gas and O₂ gas, for example, may be supplied as the first gas and the second gas, respectively. Specifically, HCD gas is supplied into the processing space 205 in the first step, and O₂ gas is supplied into the processing space 205 in the second step. A purge step may be further performed between the first step and the second step to exhaust the inner atmosphere of the processing space 205 while supplying N₂ gas. The combination of the first step the purge step and the second step may be performed a plurality of times to form a SiO film.

<Substrate Unloading Step S206>

Hereinafter, a substrate unloading step S206 will be described. In the substrate unloading step S206, the processed wafer W is unloaded from the vessel 202 in the order reverse to that of the substrate loading and heating step S202.

<Determination Step S208>

Hereinafter, a determination step S208 will be described. In the determination step S208, the controller 400 determines whether the film-forming step S204 is performed a predetermined number of times When the controller 400 determines, in the determination step S208, that the film-forming step S204 is not performed the predetermined number of times (“NO” in FIG. 15), the steps S202 through S206 are performed again to process the wafer W. When the controller 400 determines, in the determination step S208, that the film-forming step S204 is performed the predetermined number of times (“YES” in FIG. 15), the substrate processing is terminated.

(8) Method of Managing Substrate Processing Apparatus

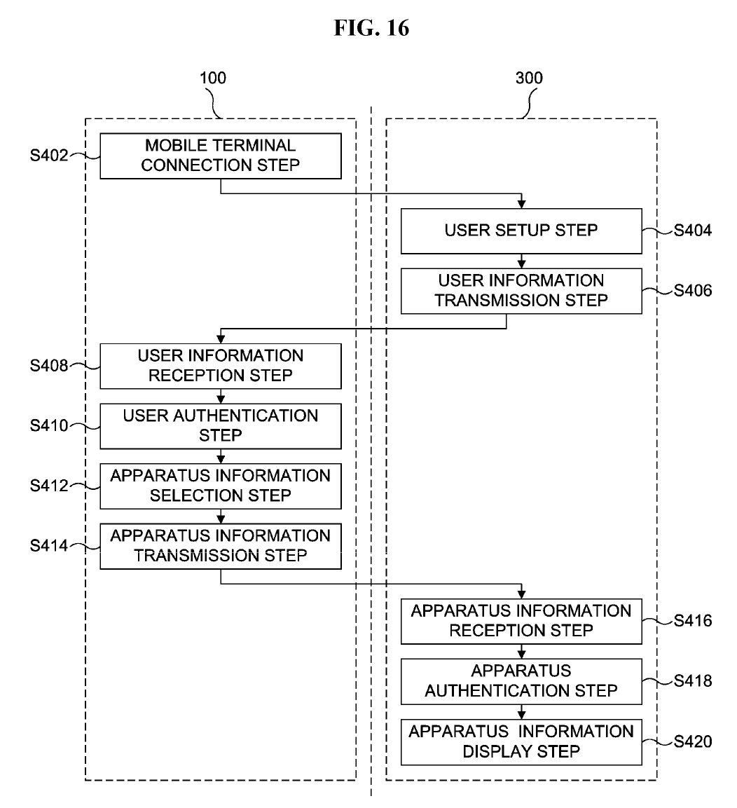

Next, a method of managing the substrate processing apparatus 100 using the mobile terminal 300 will be described with reference to FIG. 16. FIG. 16 is a flowchart illustrating processes between the substrate processing apparatus 100 and the mobile terminal 300. The operations of the substrate processing apparatus 100 and the mobile terminal 300 are shown in the left side and the right side of the dotted line shown in FIG. 16, respectively.

<Mobile Terminal Connection Step S402>

A mobile terminal connection step S402 performed by the substrate processing apparatus 100 will be described. In the mobile terminal connection step S402, when the mobile terminal 300 requests a connection, the CPU 401 determines whether the connection should be allowed. When the connection is determined to be allowed, the CPU 401 establishes the connection to the mobile terminal 300.

<User Setup Step S404>

A user setup step S404 performed by the mobile terminal 300 will be described. In the user setup step S404, for example, when a maintenance personnel affiliated with the substrate processing apparatus manufacturer manages the substrate processing apparatus 100 via the mobile terminal 300 using the main user “MAINTENANCE PERSONNEL S”, the main user “MAINTENANCE PERSONNEL S” is allowed to setup sub-users of the main user “MAINTENANCE PERSONNEL S”. For example, the main user “MAINTENANCE PERSONNEL S” can setup the sub-user “PROCESS ENGINEER” by entering “MAINTENANCE PERSONNEL S” as the main user and “PROCESS ENGINEER” as the sub-user via the input device 301.

The CPU 311 determines whether the main user and the sub-user are registered users defined in the main user management table_M 324 and the sub-user management table M 325, respectively. If the main user and the sub-user are registered users, the CPU 311 allows the sub-user to access (use) the mobile terminal 300.

<User Information Transmission Step S406>

A user information transmission step S406 performed by the mobile terminal 300 will be described. In the user information transmission step S406, the CPU 311 transmits information about the user (“user information”) setup in the user setup step S404 to the substrate processing apparatus 100. The user information includes the main user ID and the sub-user ID. The user information may be transmitted at the confirmation of the user.

<User Information Reception Step S408>

A user information reception step S408 performed by the substrate processing apparatus 100 will be described. In the user information reception step S408, the transceiver 290 of the substrate processing apparatus 100b receives the user information transmitted from the mobile terminal 300.

<User Authentication Step S410>

A user authentication step S410 performed by the substrate processing apparatus 100 will be described. In the user authentication step S410, the mobile terminal authenticator 407 compares the received main user ID with the main user management table_A 413. If the received main user ID is present in the main user management table_A 413, the sub-user is then authenticated.

When authenticating the sub-user, the sub-user ID is compared with the sub-user management table_A 414. If the received sub-user ID is present in the sub-user management table_A 414, the CPU 401 grants access to the substrate processing apparatus 100 via the mobile terminal 300.

<Apparatus Information Selection Step S412>

A apparatus information selection step S412 performed by the substrate processing apparatus 100 will be described. In the apparatus information selection step S412, the apparatus information selector 408 selects information that can be accessed by the main user defined in the main user management table_A 413 based on the main user ID authenticated by the mobile terminal authenticator 407. The apparatus information selector 408 also selects information that can be accessed by the sub-user defined in the sub-user management table_A 414 based on the sub-user ID authenticated by the mobile terminal authenticator 407. For example, when the received sub-user ID is “PROCESS ENGINEER”, the apparatus information selector 408 selects monitored apparatus information, parameter management information, alarm management information and error log information according to the sub-user management table_A 414 as the information to be transmitted to the mobile terminal 300.

In the apparatus information selection step S412, as exemplified above, only the information which is allowed to be accessed by the main user “MAINTENANCE PERSONNEL S” is selected as the information to be transmitted, and the information which is not allowed to be accessed by the main user “MAINTENANCE PERSONNEL S” is not selected. Specifically, program management information and production data management information are not selected as selected as the information to be transmitted for the main user “MAINTENANCE PERSONNEL S” to prevent the transmission of the confidential information that belongs to other main users. As a result, the information of the device manufacturer can be protected.

<Apparatus Information Transmission Step S414>

A apparatus information transmission step S414 performed by the substrate processing apparatus 100 will be described. In the apparatus information transmission step S414, the CPU 401 transmits the information selected in the apparatus information selection step S412 to the mobile terminal 300 via the transceiver 290. For example, when the sub-user is “PROCESS ENGINEER”, the CPU 401 transmits monitored apparatus information, parameter management information, alarm management information and error log information to the mobile terminal 300.

<Apparatus Information Reception Step S416>

A apparatus information reception step S416 performed by the mobile terminal 300 will be described. In the apparatus information reception step S416, the terminal side transceiver 303 receives the apparatus information from the transceiver 290 of the substrate processing apparatus 100.

<Apparatus Authentication Step S418>

A performed by the mobile terminal 300 will be described. In the apparatus authentication step S418, the substrate processing apparatus authenticator 317 of the CPU 311 compares the apparatus ID contained in the received apparatus information with the apparatus management number table_M 321. If the received apparatus ID is present in the apparatus management number table_M 321, the CPU 311 regards the received apparatus information as information to be displayed on the mobile terminal 300.

When a plurality of apparatus IDs are simultaneously received through the near-field wireless communication, each apparatus ID is displayed on the display device 302, and the user can select one of the apparatus ID to view the corresponding apparatus information of the substrate processing apparatus.

<Apparatus information Display Step S420>

A apparatus information display step S420 performed by the mobile terminal 300 will be described. In the apparatus information display step S420, the CPU 311 reads the sub-user management table_M 325 and selects a display format assigned for the corresponding user. For example, when the user is “PROCESS ENGINEER”, the CPU 311 selects the display format F02.

The mobile terminal 300 displays the apparatus information of the substrate processing apparatus 100b on the display device 302 according to the selected display format.

The maintenance personnel may manage the substrate processing apparatus 100 by performing maintenance based on the information displayed on the display device 302.

Hereinafter, the reason for storing the sub-user management table_M 325 in the mobile terminal 300 will be described. As described above, the substrate processing apparatus is managed by various administrators. Since the security clearances of administrators differ, the range of accessible information differs for each administrator. In particular, the range of information accessible by the administrator affiliated with the device manufacturer differs from the range of information accessible by the administrator affiliated with the substrate processing apparatus manufacturer. That is, the range of information accessible by the administrator affiliated with the substrate processing apparatus manufacturer is more limited compared to the range of information accessible by the administrator affiliated with the device manufacturer.

For comparison, it is assumed that the mobile terminal 300 receives the entirety of apparatus information and selectively displays the apparatus information depending on the user. “The entirety of apparatus information” refers to monitored apparatus information, program management information, parameter management information, production data management information, alarm management information and error log the information shown in FIG. 6.

If the entirety of apparatus information is transmitted to the mobile terminal 300, it is possible that an administrator affiliated with the substrate processing apparatus manufacturer obtains access to the entirety of apparatus information in case of a malfunction of the mobile terminal 300. For example, the user “MAINTENANCE PERSONNEL S” affiliated with the substrate processing apparatus manufacturer may gain access to program management information and production data management information, resulting in the violation of the device manufacturer's security policy.

According to the embodiment, before transmitting the apparatus information to the mobile terminal 300, the information is selected according to security clearance, and only the selected information according to the security clearance is transmitted to and stored in the mobile terminal 300 to prevent leakage of the information.

As described above, since only the information selected from the entirety of the apparatus information of the substrate processing apparatus 100 is transmitted to the mobile terminal 300, the mobile terminal 300 is granted access to only the selected and necessary information. As a result, the security level is enhanced.

A wired connection can be established between the substrate processing apparatus 100 and the mobile terminal 300 via the terminal side transceiver 303 and the mount 123. If there is no communication restriction in the clean room, a wireless connection may be established between the substrate processing apparatus 100 and the mobile terminal 300 via the terminal side transceiver 303. The wireless connection refers to, for example, near-field wireless communication.

When the substrate processing apparatus 100 is wirelessly connected to the mobile terminal 300, the substrate processing apparatus 100 can broadcast the substrate processing apparatus ID within a predetermined range with respect to the substrate processing apparatus 100. When the mobile terminal 300 enters the predetermined range and receives the substrate processing apparatus ID, the substrate processing apparatus authenticator 317 determines whether the substrate processing apparatus 100 is apparatus to be managed. When the substrate processing apparatus 100 is determined to be apparatus to be managed, the mobile terminal 300 displays the apparatus information of the substrate processing apparatus 100 as described above.

The mobile terminal 300 may automatically receive the apparatus information of the substrate processing apparatus 100 when the substrate processing apparatus 100 broadcasts the substrate processing apparatus ID wirelessly. Therefore, since the operation of determining whether the substrate processing apparatus 100 is apparatus to be managed and the operation of manually connecting the substrate processing apparatus 100 to the mobile terminal 300 are unnecessary, the user of the mobile terminal 300 can view the apparatus information of the substrate processing apparatus 100 and manage the of the substrate processing apparatus 100 without delay, thereby improving the maintenance efficiency.

When both of the substrate processing apparatus 100a and the substrate processing apparatus 100b adjacent to each other transmit the substrate processing apparatus IDs, the mobile terminal 300 receives both of the substrate processing apparatus IDs and provides a screen for selecting one of the substrate processing apparatus 100a and the substrate processing apparatus 100b to the administrator. For example, when the mobile terminal 300 is at a location where both of the substrate processing apparatus IDs can be received, the mobile terminal 300 receives both of the substrate processing apparatus IDs, authenticates and displays a screen on the display device 302 for selecting one of the substrate processing apparatus 100a and the substrate processing apparatus 100b.

The mobile terminal 300 can be shared between the substrate processing apparatuses 100 by establishing a direct connection. As a result, the manufacturing cost of the substrate processing apparatus can be reduced by eliminating the need for providing a management device for each substrate processing apparatus. The administrator can perform maintenance by continuously viewing the apparatus information of each substrate processing apparatus using the mobile terminal 300, thereby improving the maintenance efficiency.

Since the mobile terminal 300 is connected to the substrate processing apparatuses by wired or wireless communication, each substrate processing apparatus can be managed even in the clean room which requires high security level.

While the embodiment is described by way of an example wherein the mobile terminal 300 is connected to the substrate processing apparatus 100, the above-described technique is not limited thereto. For example, the reactors 200a, 200b, 200c and 200d may be directly connected to the mobile terminal 300. For example, the mobile terminal 300 may be connected to the reactors 200a, 200b, 200c and 200d via the mounts 201a, 201b, 201c and 201d.

The display device of a conventional cluster type substrate processing apparatus is often provided on the wall of an atmospheric transfer chamber of the conventional cluster type substrate processing apparatus, i.e. the wall of the main corridor 503 of the clean room shown in FIG. 1 in order to enable the administrator to check the state of conventional cluster type substrate processing apparatus from the main corridor 503.

The state of the components of the reactor 200c such as the mass flow controllers 243c, 244c and 245c and the valves 243d, 244d and 245d are checked during the maintenance simultaneously with the state of the reactor 200c of the apparatus shown in FIG. 2. Conventionally, an administrator performs maintenance by moving back and forth between the reactor 200c and the display device provided on the wall of the atmospheric transfer chamber. As a result, the maintenance efficiency is significantly degraded.

In contrast, according to the above-described technique, the mobile terminal 300 is connected to the reactors 200a, 200b, 200c and 200d via the mounts 201a, 201b, 201c and 201d provided at the reactors 200a, 200b, 200c and 200d, respectively, to receive apparatus management numbers and monitored apparatus information. As a result, the administrator can simultaneously monitor the apparatus information while performing maintenance of the parts to improve the maintenance efficiency.

While the embodiment is described by way of an example wherein the substrate processing apparatus 100 authenticates the mobile terminal 300 using the user ID, the above-described technique is not limited thereto. For example, a unique ID may be assigned to each of plurality of mobile terminals, and the substrate processing apparatus 100 may authenticate the plurality of mobile terminals using the unique ID and referring to the mobile terminal authentication table 416 shown in FIG. 4. The mobile terminal authentication table 416 contains management numbers (IDs) of mobile terminals and is used for identifying the mobile terminals.

The substrate processing apparatus 100 is capable of identifying the plurality of mobile terminals accessing the substrate processing apparatus 100 from one another even when the plurality of mobile terminals simultaneously access the substrate processing apparatus 100. Therefore, it is possible to operate the substrate processing apparatus 100 individually as well as displaying apparatus information via mobile terminals.

Whenever the mobile terminal 300 is replaced or the number of mobile terminals 300 is increased, the mobile terminal authentication table 416 must be updated. The update of the table itself or the program that reads the table may cause a failure of the substrate processing apparatus, resulting in increase in down time of the substrate processing apparatus. Such situation is undesirable for the device manufacturer. If excessive and unnecessary down time occurs, the reliability of the substrate processing apparatus manufacturer is degraded.

However, when the mobile terminal 300 is authenticated using the user ID as described above, it is not necessary to update the table of the substrate processing apparatus 100 even when the mobile terminal 300 is replaced or the number of the mobile terminal 300 is increased. As a result, the substrate processing apparatus 100 can be operated stably.

<Other Embodiments>

While the technique is described in detail by way of the above-described embodiment, the above-described technique is not limited thereto. The above-described technique may be modified in various ways without departing from the gist thereof.

While the embodiment is described by way of an example wherein the mobile terminal connection step S402 is performed before the user information transmission step S406, the above-described technique is not limited thereto. For example, the mobile terminal connection step S402 and the user information transmission step S406 may be performed simultaneously.

While the embodiment is described by way of an example film-forming process performed in a substrate processing apparatus wherein HCD gas and O₂ gas are alternately supplied as a first element-containing gas (first process gas) and a second element-containing gas, respectively, to form an SiO film on a wafer. However, the above-described technique is not limited thereto. For example, the gases used in the example film-forming process are not limited to HCD gas and O₂ gas. That is, the above-described technique may be applied to film-forming processes wherein other gases are used to form different thin films, or three or more different gases are supplied in turn to form a thin film. Specifically, instead of silicon (Si), the first element may include element such as titanium (Ti), zirconium (Zr) and hafnium (Hf) instead of silicon. Instead of oxygen (O), the second element may include element such as nitrogen (N).

While the embodiment is described by way of an example wherein a film-forming process is performed in a substrate processing apparatus, the above-described technique is not limited thereto. That is, the above-described technique can be applied not only to the film-forming process for forming the thin film exemplified in the embodiment but also to different substrate processing. For example, the above-described techniques may be applied to annealing, diffusion, oxidation, nitridation and lithography. The above-described technique may also be applied to other substrate processing apparatuses such as an annealing apparatus, an etching apparatus, an oxidation apparatus, a nitridation apparatus, an exposure apparatus, a coating apparatus, a drying apparatus, a heating apparatus and combinations thereof. The above-described technique may also be applied when a constituent of one of the above-described examples is substituted with another constituent of other examples, or when a constituent of one of the above-described examples is added to other examples. The above-described technique may also be applied when the constituent of the examples is omitted or substituted, or when a constituent added to the examples.

According to the technique described herein, more efficient production management may be provided.

What is claimed is:

1. A method of manufacturing a semiconductor device, comprising:
(a) loading a substrate into a reactor via a transfer chamber provided in a substrate processing apparatus, and processing the substrate in the reactor;
(b) detecting a state of the reactor or a state of the transfer chamber, and generating monitored apparatus information representing the state of the reactor or the state of the transfer chamber;
(c) connecting a common mobile terminal to the substrate processing apparatus;
(d) acquiring user information by the common mobile terminal;
(e) transmitting the user information from the common mobile terminal to the substrate processing apparatus;
(f) transmitting the monitored apparatus information from the substrate processing apparatus to the common mobile terminal, and receiving the monitored apparatus information by the common mobile terminal; and
(g) displaying the monitored apparatus information on a display device provided in the common mobile terminal.
